(19) United States
(12) Patent Application Publication
(10) Pub. No.: US 2023/0419343 A1
(43) Pub. Date: Dec. 28, 2023

(54) SYSTEMS AND METHODS FOR ARTIFICIAL INTELLIGENCE GUIDED SELLLING

(71) Applicant: ZS Associates, Inc., Evanston, IL (US)

(72) Inventors: Nishant Gupta, New York City, NY (US); Alankrit Gupta, Indianapolis, IN (US); Mayank Shah, New Delhi (IN); Kyle Heller, Belmont, CA (US); Vikas Singhal, New Delhi (IN)

(73) Assignee: ZS Associates, Inc., Evanston, IL (US)

(21) Appl. No.: 18/215,096

(22) Filed: Jun. 27, 2023

Related U.S. Application Data
(60) Provisional application No. 63/356,299, filed on Jun. 28, 2022.

(51) Int. Cl. G06Q 30/0202; G06Q 30/0207; G06Q 30/0241; G06Q 30/0251

(52) U.S. Cl. CPC G06Q 30/0202; G06Q 30/0264; G06Q 30/0249; G06Q 30/0207

(57) ABSTRACT

A method may include identifying a dataset corresponding to an entity. The dataset may include characteristics of the entity, historic actions performed by the entity, and historic events involving the entity. The historic actions can be associated with one or more products or services. The method may include generating a hierarchy data structure corresponding to the entity based on the dataset. The hierarchy data structure can define a first data level for a first subset of the dataset and a second data level for a second subset of the dataset. The method may include generating a feature set based on a first featurization process applied to the first subset and a second featurization process applied to the second subset. The method may include executing a machine-learning model associated with the entity using the feature set as input.

### CROSS-REFERENCE TO RELATED APPLICATIONS

The present application claims priority to U.S. Application No. 63/356,299, filed Jun. 28, 2022, which is incorporated herein by reference in its entirety for all purposes.

### TECHNICAL FIELD

The present disclosure relates to the field of artificial intelligence and knowledge processing systems for generating feature sets and generating sets of machine-learning models based on hierarchical data associated with one or more entities.

### BACKGROUND

Artificial intelligence (AI) models, such as classification models and regression models, can be used to process a variety of input data. Generally, artificial intelligence models are created and trained to address application-specific problems. Manually defining and curating sets of data for these models is time-consuming and often produces inconsistent and less-than-optimal results.

### SUMMARY

For the aforementioned reasons, there is a need to improve processes to automatically generate sets of models to classify, regress, or otherwise process, information from different and disparate sources. For instance, information relating to an entity can be curated, such as customer, and use the techniques described herein to select and generate machine-learning models based on datasets associated with that entity. Some example models include models to determine a probability of customer churn, models to identify cross-selling opportunities, and models to identify potential upselling opportunities. The techniques described herein can provide an improved process for selecting types of models to achieve such outputs, and to determine optimized hyperparameters for the selected models, based on the datasets associated with the entity. The machine-learning techniques described herein can additionally provide trained explainer models, which can be utilized to generate human-readable explanations of model outputs. These explanations can include or otherwise indicate one or more actions to rectify any undesirable prediction generated by the models, or to take advantage of an identified upselling or cross-selling opportunity.

Additionally, the techniques described herein provide techniques for featurization of the datasets associated with the entities, to streamline and improve the computational efficiency of the automated processes described herein. Datasets associated with entities, although typically structured, are often too large to be practically used to train artificial intelligence models efficiently. To address these issues, the techniques described herein provide for a data hierarchy-based featurization process, which can be used to select featurization processes for particular portions of the dataset. The generated features are features that are generally more likely to include useful information for predicting or regressing information of interest. Using featurization, the input dataset can be reduced to the most useful portions of the datasets associated with the entities, without sacrificing the overall accuracy of the system. This improves the computational efficiency of automatically generating and utilizing the machine-learning models in connection with large numbers of entities, and is, therefore, a technical improvement over other implementations.

In an embodiment, a method includes identifying a dataset corresponding to an entity. The dataset includes a plurality of characteristics of the entity, a plurality of historic actions performed by the entity, and a plurality of historic events involving the entity. The plurality of historic actions can be associated with one or more products or services. The method includes generating a hierarchy data structure corresponding to the entity based on the dataset corresponding to the entity. The hierarchy data structure defines a first data level for a first subset of the dataset and a second data level for a second subset of the dataset. The method includes generating a feature set based on a first featurization process applied to the first subset and a second featurization process applied to the second subset. The method includes executing a machine-learning model associated with the entity using the feature set as input.

The method may include generating an explanation value based on an output of the machine-learning model. The plurality of characteristics may include at least one second characteristic of a second entity associated with the entity, and the plurality of historic actions may include at least one second historic action performed by the second entity. The hierarchy data structure may separate the dataset corresponding to the entity into at least two categories based on a type of information in the dataset.

The method may include combining an output of the first featurization process with an output of the second featurization process to generate the feature set. The first subset of the dataset may correspond the entity and the second subset of the dataset corresponds to the entity and a sub-entity of the entity. The first featurization process or the second featurization process may include an aggregation or replication process. The machine-learning model may include a plurality of models. Executing the machine-learning model may include providing, by the one or more processors, the feature set as input to the plurality of models. The plurality of models may include at least one clustering model. The method may include updating the machine-learning model responsive to generating the feature set.

In an embodiment, another method includes identifying a feature set generated based on a dataset corresponding to an entity. The method includes selecting a subset of a plurality of models for the feature set based on providing at least a portion of the feature set as input to the plurality of models. The method includes training the subset of the plurality of models using the feature set as training data. Each model of the subset is configured to generate a recommended action resulting from input data. The method includes storing the subset of the plurality of models in association with an identifier of the entity.

The dataset may include a plurality of characteristics of the entity, a plurality of historic actions performed by the entity, and a plurality of historic events involving the entity. The plurality of models may include a churn model, an up-sell model, and a cross-sell model. The plurality of models may include at least one of a linear regression model, a random forest model, a sparse vector machine (SVM) model, or an extreme gradient boosting (XGBoost) model. Selecting the subset of the plurality of models may include determining a respective set of hyperparameters for each model of the subset of the plurality of models.

Selecting the respective set of hyper parameters may include performing a randomized search over a hyperparameter range based on a type of the model. The method may include updating at least one model of the subset responsive to an update to the dataset corresponding to the entity. The method may include updating at least one model of the subset after a predetermined time period has elapsed. Each of the subset of the plurality of models may further include an explainer model. The method may include presenting a result of training the subset of the plurality of models.

At least one other aspect of the present disclosure is directed to a method. The method may be performed, for example, by one or more processors coupled to memory (e.g., a non-transitory memory). The method includes identifying a feature set generated based on datasets of a plurality of entities associated with a seller. The method includes providing the feature set as input to a plurality of machine-learning models trained based on training data associated with the seller. The method includes generating one or more human-readable recommendations based on the output of the plurality of machine-learning models. The method includes providing the one or more human-readable recommendations to a user device for presentation in a user interface.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. For example, by appropriate computer programs, which may be carried on appropriate carrier media (computer readable media), which may be tangible carrier media (e.g. disks) or intangible carrier media (e.g. communications signals). Aspects may also be implemented using suitable apparatus, which may take the form of programmable computers running computer programs arranged to implement the aspect. As used in the specification and in the claims, the singular form of “a,” “an,” and “the” include plural referents unless the context clearly dictates otherwise.

### BRIEF DESCRIPTION OF THE DRAWINGS

FIG. 1 is a schematic illustration of an example system for generating feature sets based on datasets corresponding to entities, according to an embodiment.

FIG. 2 is an example diagram showing an example hierarchy of data associated with an entity, according to an embodiment.

FIG. 3 is a schematic illustration of a flow of data in a feature set generation process, according to an embodiment.

FIG. 4 is a flowchart illustrating a method of generating feature sets based on datasets corresponding to entities, according to an embodiment.

FIG. 5 is a schematic illustration of an example system for selecting and training models based on features of entities, according to an embodiment.

FIG. 6 is an example data flow diagram showing an example configuration of multiple machine-learning models, according to an embodiment.

FIG. 7 is a diagram showing implementations of explainer models, which may be utilized with one or more of the machine-learning models described herein, according to an embodiment.

FIG. 8 is an example data flow diagram showing how data is processed utilizing the techniques described herein, according to an embodiment.

FIG. 9 is a flowchart illustrating a method of selecting and training models based on features of entities, according to an embodiment.

FIG. 10 is an example user interface showing a performance summary of a seller organization, according to an embodiment.

FIG. 11 is an example user interface showing an overlay that includes some of the signals derived from the machine learning techniques described herein, according to an embodiment.

FIG. 12 is an example user interface showing a list of recommendations for various customers of the seller, according to an embodiment.

FIG. 13 is an example user interface showing details of a customer, including recommendations or actions generated using the techniques described herein, according to an embodiment.

FIG. 14 is an example user interface showing a summary of various customers or potential customers of a seller, according to an embodiment.

FIG. 15 is an example user interface showing adoption impact of the present techniques for different sellers, according to an embodiment.

FIG. 16 is an example user interface showing an example chatbot that may be used to provide requests to the processing systems described herein, according to an embodiment.

### DETAILED DESCRIPTION

Non-limiting examples of various aspects and variations of the embodiments are described herein and illustrated in the accompanying drawings.

One or more embodiments described herein generally relate to systems and methods for generating feature sets based on datasets corresponding to entities. The processes used to generate the feature sets can be automatically determined based on a hierarchical representation of an input dataset. Generally, datasets corresponding to entities are large and difficult to use in machine-learning processes, because typically only a subset of the large input dataset includes information that is relevant for performing relevant predictions. The systems and methods described herein can identify and extract these important features using an improved feature extraction process, which structures the dataset of the entity into a hierarchical data structure. The hierarchical data structure can separate or identify respective portions of the dataset by hierarchy. Based on the data level of any portion of the dataset, the systems and methods described herein can apply a corresponding feature generation process to the respective portion of the dataset. This allows for the automatic generation of useful features for the automated machine-learning processes described herein.

At least one other embodiment described herein is directed to selecting and training models based on features of entities. Artificial intelligence model generation for application-specific situations is typically performed through slow, manual processes. However, when an application utilizes several models for many different entities, each with their own corresponding dataset, manual processes become impracticable. To address these issues, the systems and methods described herein utilize an automatic model generation process, which can be used to select and train a suite of models based on desired outputs for an entity. Some example models include models to determine a probability of customer churn, models to identify cross-selling opportunities, and models to identify potential upselling opportunities. These models can be generated at any level of granularity, for example, on a customer-by-customer basis for a seller. Additionally, the models can be trained with corresponding explanation models, which produce output that can be used to indicate to a seller one or more actions to take to, for example, act on a potential sales opportunity or mitigate a potential loss of customer. The models can be selected and generated based on the feature sets produced for each entity. Producing these machine-learning models in an automated fashion improves the computational efficiency and accuracy of model production, permitting large numbers of models to be generated for each of a seller's customers or potential customers.

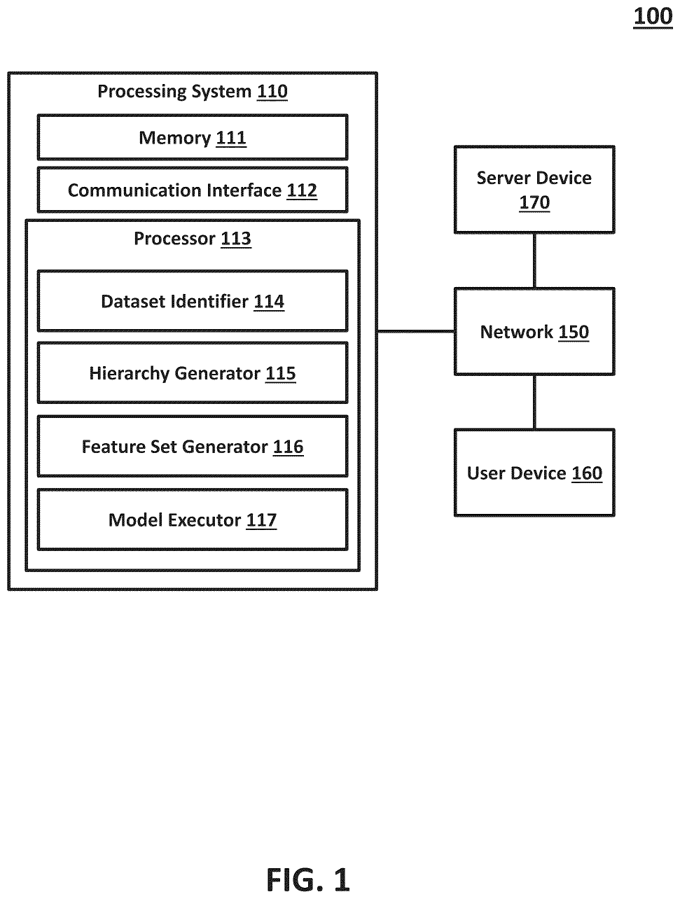

FIG. 1 is a schematic illustration of an example system 100 for generating feature sets based on datasets corresponding to entities, according to an embodiment. The system 100 can be used to generate feature sets from any type of information relating to an entity, which may be a customer or other entity of interest. The example data that can be featurized using the techniques described herein may include, but is not limited to, entity characteristic features, data relating to actions performed by the entity (e.g., product purchases, purchase periodicity, products viewed or considered by the entity, etc.), as well as information relating to campaigns or information provided to the entity relating to one or more products, services, discounts, or other information related to sales. The system 100 can include a processing system 110, a user device 160, and a server 170. The processing system 110, the user device 160, and/or the server 170 can be operatively coupled to each other via a network 150. The processing system 110 includes a memory 111, a communication interface 112, and a processor 113.

The memory 111 of the processing system 110 can be, for example, a memory buffer, a random access memory (RAM), a read-only memory (ROM), a hard drive, a flash drive, a secure digital (SD) memory card, a compact disk (CD), an external hard drive, an erasable programmable read-only memory (EPROM), an embedded multi-time programmable (MTP) memory, an embedded multimedia card (eMMC), a universal flash storage (UFS) device, and/or the like. The memory 111 can store, for example, one or more software modules that include processor-executable or processor-interpretable instructions to cause the processor 113 to execute one or more processes or functions (e.g., a dataset identifier 114, a hierarchy generator 115, a feature set generator 116, and/or a model executor 117). The memory 111 can be or include non-transitory memory.

The communication interface 112 of the processing system 110 can include a software component (e.g., executed by processor 113) and/or a hardware component of the processing system 110 to facilitate data communication between the processing system 110 and external devices (e.g., the user device 160, the server 170, other computing systems, etc.) or internal components of the processing system 110 (e.g., the memory 111 and/or the processor 113). The communication interface 112 can be operatively coupled to and used by the processor 113 and/or the memory 111. The communication interface 112 can be, for example, a network interface card (NIC), a Wi-Fi™ module, a Bluetooth® module, an optical communication module, or any other suitable wired or wireless communication interface.

The communication interface 112 can be configured to communicatively couple the processing system 110 to the network 150, as described in further detail herein. In some instances, the communication interface 112 can facilitate receiving and/or transmitting data via the network 150. More specifically, in some implementations, the communication interface 112 can facilitate receiving and/or transmitting one or more datasets (e.g., datasets corresponding to an entity) and/or feature sets, machine-learning models, or other data related to the techniques described herein, through the network 150 from/to the user device 160 and/or the server 170.

The processor 113 can be, for example, a hardware-based integrated circuit (IC) or any other suitable processing device configured to run or execute a set of instructions or a set of code. For example, the processor 113 can include a general-purpose processor, a central processing unit (CPU), an accelerated processing unit (APU), an application-specific integrated circuit (ASIC), a field-programmable gate array (FPGA), a programmable logic array (PLA), a complex programmable logic device (CPLD), a programmable logic controller (PLC), a graphics processing unit (GPU), a neural network processor (NNP), a tensor processing unit (TPU), and/or the like. The processor 113 can be operatively coupled to the memory 111 and/or the communication interface 112 through a system bus (for example, an address bus, a data bus, and/or a control bus, not shown).

The processor 113 can include a dataset identifier 114, a hierarchy generator 115, a feature set generator 116, and/or a model executor 117, each of which can include software stored in the memory 111 and executed by the processor 113. For example, code to cause the dataset identifier 114 to retrieve or identify datasets corresponding to entities can be stored in the memory 111 and executed by the processor 113. Alternatively or in addition, each of the dataset identifier 114, the hierarchy generator 115, the feature set generator 116, and/or the model executor 117 can be or include a hardware-based device.

The dataset identifier 114 can identify one or more datasets corresponding to different entities. The entities may be, for example, customers of a seller that utilizes the processing system 110 to generate feature sets. Data sets may be retrieved or received from one or more data sources, such as the server 170. The server 170 may provide information to include in one or more datasets via the network 150. The dataset identifier 114 may identify one or more datasets corresponding to an entity in response to a request, such as a request provided via a user interface. The user interface can be a web-based interface (e.g., an HTML web interface, etc.), through which an end-user (e.g., of a seller that utilizes the processing system 110) provides one or more portions of the dataset for an entity.

For example, the dataset identifier 114 may provide (e.g., host) a web-based interface that a seller can access via the user device 160. The web-based interface may include fields or other user interface elements that receive identifiers of data sources, from which the dataset identifier 114 can retrieve the datasets corresponding to one or more user-specified entities. The locations (e.g., a uniform resource locator (URL), a uniform resource identifier (URI), etc.) may be specified as part of a request to identify and generate features for a dataset. The request can include transmitted via the web-based interface provided by the dataset identifier 114, and can include various identifiers related to the entity. For example, the request may include an identifier of the entity (sometimes referred to herein as a “target entity”), an identifier of an owner of the target entity (sometimes referred to herein as a “parent entity), or an identifier of one or more products, services, users, or leads corresponding to the target entity (sometimes referred to herein as one or more “child entities”).

Some example data sources may include, but are not limited to, customer relations management (CRM) databases, customer databases, sales information databases, advertising databases, advertisement impression data records (e.g., storing one or more advertisements viewed or provided to the target entity or its parent/child(ren), storing advertisements provided by the target entity, etc.), web servers, or other data repositories that may be maintained by or are accessible by the seller utilizing the processing system 110. Additionally, the dataset identifier 114 can detect updates to any of these data sources (e.g., by querying the data source periodically to check for updates, by receiving a message from the data source in response to an update, etc.).

The request to identify datasets may include one or more authentication credentials (e.g., username, password, secret key, etc.) for the processing system 110, which the dataset identifier 114 can use to access corresponding data sources and retrieve or otherwise identify data. In some implementations, the dataset identifier 114 can identify datasets stored in a predetermined data repository, which may store data related to a target entity that has undergone a pre-processing process (e.g., a labelling process which labels individual data with a corresponding data level, a parent, target, or child entity identifier, etc.).

The datasets identified by the dataset identifier 114 can include, but are not limited to, entity characteristic features, which may include qualitative and quantitative summaries for upper, current, and lower business hierarchy for the target entity. Some examples of such data can include a number of entity children of the target entity (e.g., number of leads, number of products, etc.). The identified data in the datasets of a target entity can also include information about the parent quantity campaign design data, such as the number of campaigns (e.g., advertising or sales) that are being run by the target entity, as well as the allocated spending amount on the campaigns. The identified data in the datasets of a target entity can include information about campaigns that target the target entity (e.g., advertising or sales campaigns that the seller directs to the target entity), which may include a number of targeted campaigns as well as the frequency of promotions provided to the target entity.

In addition to information about the target entity, the dataset identifier 114 can identify information about a parent entity associated with the target entity. The parent entity may be an owner of the target entity (e.g., the target entity may be a subsidiary or group that is part of the parent entity). For example, the datasets identified by the dataset identifier 114 can include information relating to the parent entity characteristic features, as well as qualitative and quantitative summaries for current and lower hierarchy of the parent entity. This can include information about the industry segment associated with the parent entity, as well as the number of sub-divisions of the parent entity. The parent entity data of the dataset can include information about the number of advertising campaigns run by the parent entity, as well as the allocated advertising spend by the parent entity. The parent entity data of the dataset can include information about success metrics of the seller's advertisement campaigns that are directed to the parent entity, as well as a total amount of revenue achieved by the seller from the parent entity.

The dataset identifier 114 can identify information about child entities associated with the target entity as part of the dataset. The data associated with the child entities can have a higher granularity than the data associated with the target entity or the parent entity. Child entities may be, for example, information related to leads (e.g., users that make sales decisions) of the target entity. For example, the child entity information may include a type of lead, a source of the lead, as well as types of accounts associated with or managed by the target entity. The child entity data identified as part of the dataset may also include transactional quantitative data, as well as campaign design features (e.g., characteristics of campaigns run by the target entities, etc.), and may include identifiers of campaigns executed by the target entity and their respective characteristics. The child entity data identified as part of the dataset may also include information relating to interactions by the seller with one or more leads of the target entity, such as call duration or email response time.

Generally, the data in the datasets identified by the dataset identifier 114 can include any information about the target entity, including details relating to the characteristics of the target entity (e.g., industry segment, size, etc.), information relating to actions performed by the target entity (e.g., expansion, acquisition, social media activity, other general activity, etc.), information relating to company-related actions (e.g., feedback, consumption pattern, engagement with advertising campaigns, etc.), as well as actions performed by the target entity that are specific to others (e.g., actions directed to other customers, competitors, potential customers, etc.). The data in the datasets identified by the dataset identifier 114 can also include information about events involving the target entity, which may be actions directed toward the target entity. For example, the data in the datasets may include information about historic advertising campaigns (and associated characteristics of those campaigns) directed toward the target entity or competitor actions directed toward the target entity, among others.

(The data in the datasets identified by the dataset identifier 114 can further include information about products purchased by the target entity from the seller, including any characteristics of the product, purchase frequency of the product, or other purchase details (e.g., purchase time, price, quantity, etc.). The datasets can include product or service usage data (e.g., frequency of use by the target entity, type of user of product, customer satisfaction with product, etc.). Generally, the datasets can include any type of data record (e.g., transaction record, contract, advertisement, etc.) that may be related to an interaction between the target entity and the seller.

The data in the datasets identified by the dataset identifier 114 may be stored in the memory 111, for example, in one or more data structures. Prior to processing the datasets, the datasets may be stored in association with an identifier of the target entity to which the dataset corresponds. The datasets may be stored in a structured or unstructured format, and may be retrieved from the one or more data sources periodically, in a batch retrieval process, or at predetermined time intervals. The dataset identifier 114 may assign a corresponding parent entity identifier to data associated with the parent entity of the target entity, a corresponding target entity identifier to data associated with the target entity, and a corresponding child entity identifier to data associated with a child entity of the parent entity. In some implementations, these identifiers may be assigned in an offline process by another computing system following retrieval by the dataset identifier 114. The data retrieved by the dataset identifier 114 can then be subsequently processed by hierarchy generator 115.

The hierarchy generator 115 can generate a hierarchy data structure corresponding to the target entity based on the dataset identified by the dataset identifier 114. The hierarchy data structure can define a first data level (e.g., as corresponding to one of a child entity, the target entity, or the parent entity) for a first subset of the dataset and a second data level (e.g., as corresponding to another of the child entity, the target entity, or the parent entity) for a second subset of the dataset. Because different portions of the dataset correspond to different entities, and also inherently correspond to different levels of granularity, each portion of the dataset can benefit from a corresponding type of featurization. In this way, the featurization processes described herein can be utilized in parallel, and subsequently merged to produce an improved feature set for model training and inference. In some implementations, the datasets relating to a target entity can include characteristics of, or actions performed by, related entities, such as competitors.

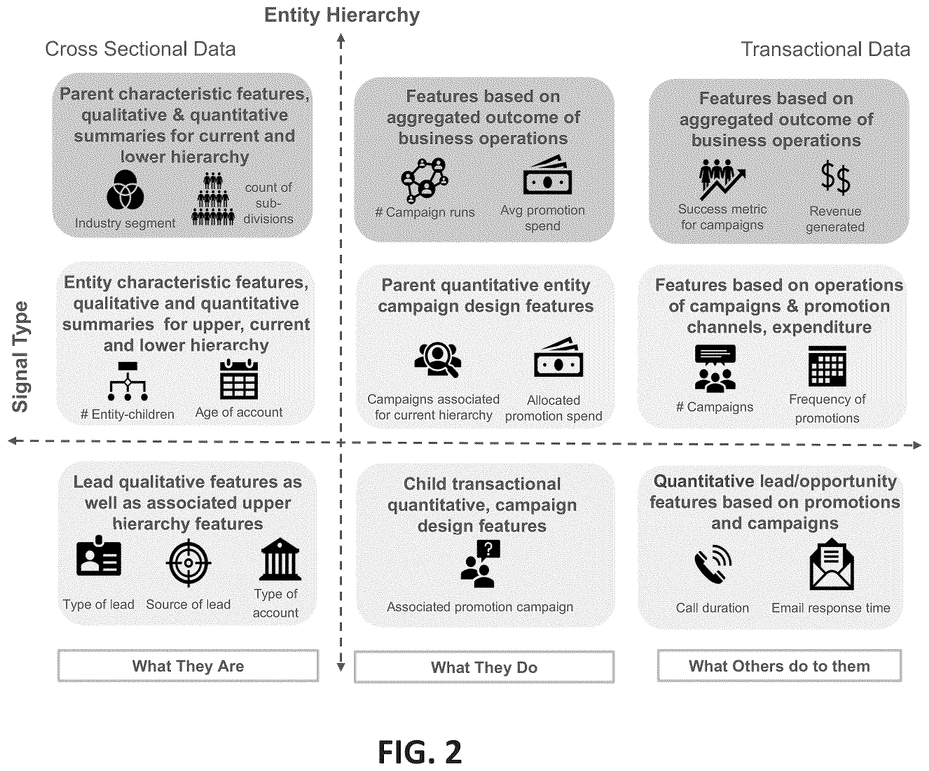

To generate the hierarchy data structure, the hierarchy generator 115 can iterate through each item of data in the dataset identified by the dataset identifier 114 to identify the corresponding data level of the item. For example, items of data corresponding to the parent entity can be assigned to a top data level of the hierarchy, while items of data corresponding to the target entity can be assigned to a middle data level of the hierarchy, and items of data corresponding to one or more child entities can be assigned to a bottom data level of the hierarchy. An example representation of this type of data organization is shown in FIG. 2.

Referring to FIG. 2, various data corresponding to a target entity (including parent entity data and child entity data) can be organized into a three-by-three data representation. However, it should be understood that such a representation is for example purposes only, and that any type of hierarchy can be established by assigning data as relating to a parent entity, a target entity, or a child entity. As shown, the data structure organization can be two-dimensional, with the entity hierarchy types being reflected on the Y-axis, and corresponding data signal types indicated on the X-axis. Data corresponding to the parent entity is shown in the top row, data corresponding to the target entity is shown in the middle row, and data corresponding to a child entity is shown in the bottom row. Similar types of data signals, each at different levels of granularity, are shown in each column. For example, the left-most column reflects information relating to characteristics of the parent, target, and child entity. This information may sometimes be referred to as “cross-sectional data.” The middle column includes information about what the entities do (e.g., as a company, historic actions performed by the entity, etc.), and the right-most column includes information about events that involve each entity (e.g., actions directed to or involving the entity). Such information (e.g., in the middle and right-most columns) may be referred to as “transactional data.”

Referring back to FIG. 1, the hierarchy generator 115 can iterate through each item of data can assign it to a corresponding “bucket,” or tag, which indicates the data falls into a particular portion of the hierarchy data structure. The hierarchy generator 115 may also apply selected elemental transformation processes to generate the hierarchy data structure. For example, the hierarchy generator 115 may apply a normalization technique to various transaction values or duration values. The hierarchy generator 115 may apply transformation processes to various items of data in order to facilitate compatibility between the raw data and the feature generation processes described herein. As such, the hierarchy generator 115 may apply dimensional transformations, or may store or structure raw data items in a regular manner that is compatible with the feature generation processes. In addition to separating data by entity, the hierarchy data structure may separate the data in the dataset based on the type of each item of data (e.g., separating characteristic data from transactional data, etc.).

In some implementations, the hierarchy generator 115 may perform a filtering process on the raw data in the dataset prior to storing the data in the hierarchy data structure. For example, the raw data in the dataset identified by the dataset identifier 114 may include extraneous or irrelevant information (e.g., information corresponding to unrelated entities, information corresponding to events or actions occurring before a predetermined time period, unnecessary metadata, etc.). The hierarchy generator 115 can exclude this irrelevant or extraneous information from the dataset, and store relevant information in the hierarchy data structure as described herein. The hierarchy data structure can, in effect, separate the (filtered, if applicable) dataset into multiple subsets, with one subset corresponding to the target entity, another subset corresponding to the parent entity, and a subset corresponding to one or more child entities. In some implementations, in response to detecting a change (e.g., an update) to the identified dataset, the hierarchy generator 115 can update the hierarchy data structure to reflect the update. This may include removing information no longer within the dataset (e.g., old or expired data), or incorporating new data into the hierarchy data structure.

The feature set generator 116 can be used to select and/or generate features and generate a feature table. The feature set generator 116 can include code stored in the memory 111 to instruct the processor 113 to access the hierarchy data structure, generate a feature table, and store the feature table. The feature set generator 116 can be used to generate a feature set associated with the target entity using multiple featurization processes. The different featurization processes may be performed based on the data level (e.g., to which entity the data corresponds) of different subsets of data in the hierarchy data structure. For example, the feature set generator 116 can perform a data replication process for the data associated with the parent entity.

Likewise, the feature set generator 116 can apply an aggregation process to the data associated with the child entities of the target entity. The feature set generator 116 can then use data aggregators on the data related to the child entities to generate a subset of aggregated features. The data aggregators can include functions, operators, models, and/or objects that roll up and/or aggregate features based on a criterion (e.g., action/event recency, action/event frequency, child entity identifier, action/event type, product type, campaign information, etc.). For example, the data aggregators can include a recency aggregator that indicates a time since the last occurrence of a feature, such as a purchase of a particular product. The data aggregators can include a count aggregator that indicates the number of occurrences of a feature in a predetermined or selected time interval. The data aggregators can include a delta count aggregator that indicates a difference in the number of occurrences of a feature in a first time period compared to a number of occurrences of a feature in a second time period.

The feature set generator 116 can utilize any type of feature processing technique. In some implementations, a subset of the data in the hierarchy data structure can be featurized using a first featurization framework, such as the Featuretools framework. Additionally, a second subset of the data in the hierarchy data structure can be featurized using a second featurization framework, such as the Plug-n-Predict framework. In some implementations, all of the data in the hierarchy data structure can be featurized using at least two featurization frameworks or processes, and subsequently combined and ranked to identify a set of top ranking features. For example, a sum of connection value on for all transactions involving the target entity, the sum of maximum of connection value for all transactions for all products involving the target entity, the number of products purchased by the target entity, the minimum revenue value of mobile broadband in the last two months, the maximum revenue value of mobile broadband in the last nine months, and the sum of data usage of mobile voice in the last ten months, can be selected or generated as relevant features for the machine-learning processes described herein. The feature set generator 116 can generate an importance score for each of the features generated by each of the feature generation processes, and rank the features by the importance score. The feature set generator 116 may filter out any features having an important score below a threshold.

The feature set generator 116 can merge the individual feature sets generated using the different featurization processes (e.g., selected based on whether the data is associated with a parent entity, a target entity, or a child entity) into an integrated feature set. If multiple featurization frameworks are utilized (e.g., Featuretools and Plug-N-Predict), then multiple integrated feature sets can be generated using similar techniques for each framework. The multiple integrated feature sets can then be integrated into a single feature set for the target entity, which may be ranked and filtered as described herein. The feature set generator 116 can store the final integrated feature set as a feature table, for example, in one or more data structures in the memory 111.

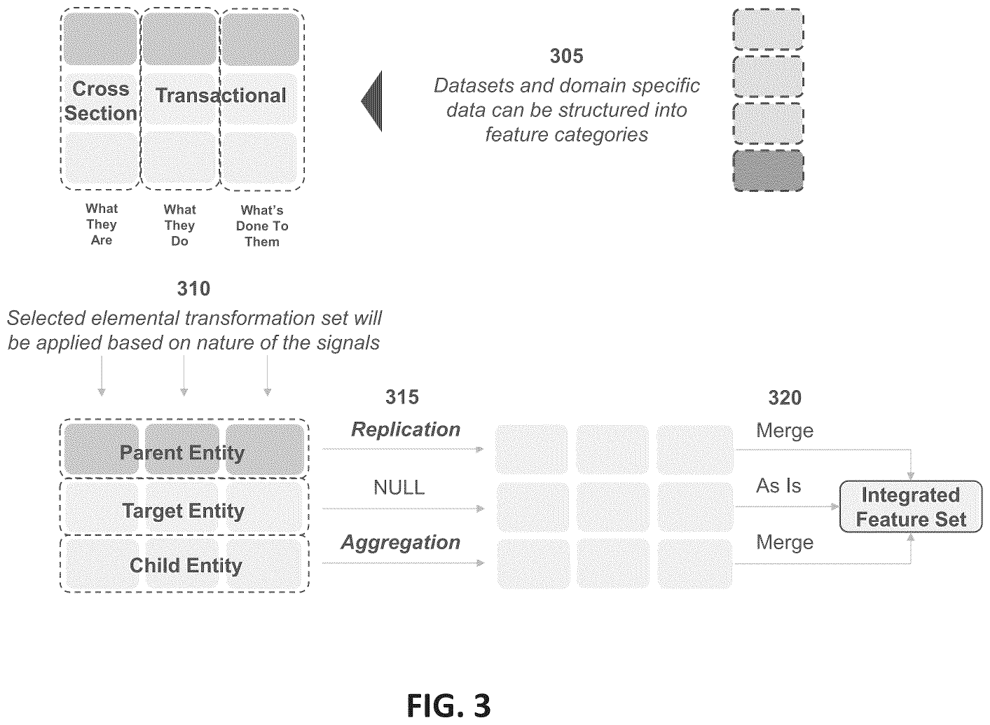

A high-level data flow diagram of the feature set generation process, as implemented by the components of the processing system 110, is shown in FIG. 3. Referring to FIG. 3 in the context of the components described in FIG. 1, illustrated is a schematic illustration of a flow of data in a feature set generation process, according to an embodiment. At step 305, the datasets and domain specific data can be identified and structured into feature categories. For example, these processes can be performed by one or more of the dataset identifier 114 and/or the hierarchy generator 115, as described herein. These categories can include cross-sectional data and transactional data, as described in connection with FIG. 2.

At step 310, a selected elemental transformation set can be applied based on the nature of the data in the data structure generated at step 305. These operations can be performed, for example, by the hierarchy generator 115, as described in further detail herein. As shown, the items of data generated at step 305 can be structured in a hierarchy (e.g., based on the parent entity, target entity, or the child entity). In doing so, the hierarchy generator 115 may filter out any extraneous or irrelevant data.

At step 315, the feature generation processes described herein can be applied to the hierarchy data structure. As shown, different featurization processes may be utilized for data that corresponds to different entities. In this example, a replication process is utilized for data corresponding to the parent entity, an aggregation process is utilized for data corresponding to the child entities, and the data corresponding to the features of the target entity itself is used as-is. However, it should be understood that alternative feature processing techniques can be selected for each subset of the hierarchy data structure corresponding to the parent entity, target entity, and child entities.

At step 320, the sets of features generated using each feature generation process can be combined into an integrated feature set. If multiple feature generation frameworks are utilized, the steps 315 and 320 may be repeated for each feature generation framework, and the multiple integrated feature sets can be combined into an integrated feature set. The resulting feature set may be stored in association with an identifier of the target entity, and may be utilized in a machine-learning process as described herein.

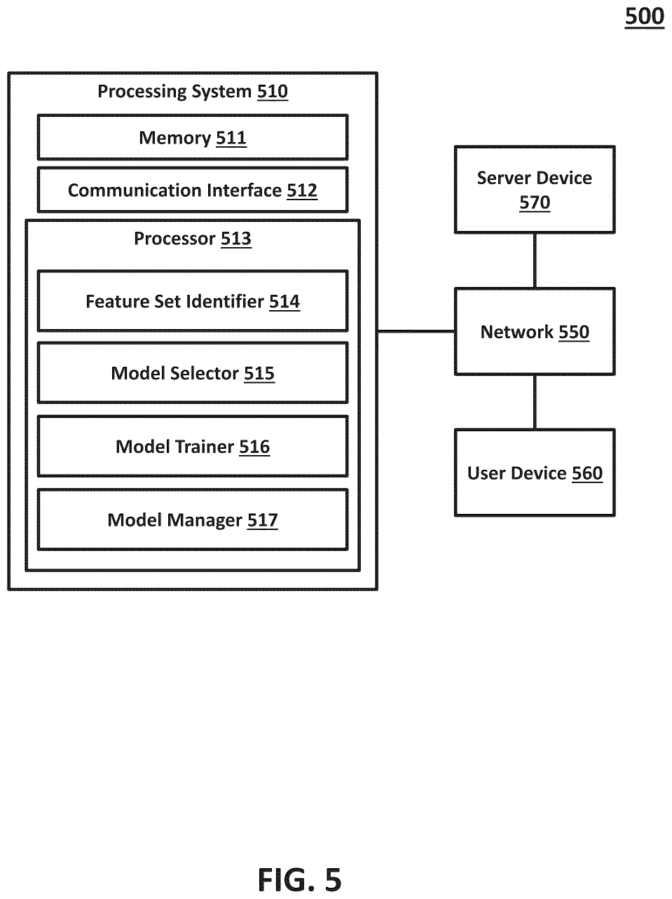

Referring back to FIG. 1, the model executor 117 can execute a machine-learning model associated with the entity using the feature set as input. Using the techniques described in connection with FIGS. 5-9, one or more machine-learning models can be generated and trained for a target entity. The machine-learning models may include a linear regression model, a random forest model, an SVM model, an XGBoost model, an explainer model, or a clustering model. After generating the feature set, the feature set can be provided as input to the one or more machine-learning models. The machine-learning models may be utilized to generate one or more output values, for example, values corresponding to a probability of customer (e.g., target entity) churn, a probability of customer leakage, a lifetime value of the customer, whether an upsell for the customer is recommended, whether a possibility of cross-selling a product to the customer exists, a prediction of a purchase value of an opportunity associated with the target entity, an estimation of the best time to call the target entity to engage in business, or one or more action to expedite an opportunity associated with the entity, among others. In some implementations, the model executor 117 can provide respective subsets of the feature set into each of the machine-learning models for the target entity, and propagate the information through the models according to the models respective algorithm and trained parameters.

The features sets generated using the techniques described herein can be utilized either in model inference (e.g., to generate predictions) or model training (e.g., to generate the set of models for the target entity). The techniques for model training are described in further detail in connection with FIGS. 5-9. As described in further detail herein, the machine-learning models can include explainer models, which can be executed by the model executor 117.

The explainer models can be trained to identify patterns in the input data that correspond to certain outputs, and indicate which features are likely the largest contributors to a particular output. For example, in executing the explainer model, the model executor 117 can generate an output that indicates which features correspond to an output that indicates a customer is likely to churn in the future. Using the outputs generated by the explainer model(s), the model executor 117 can utilize one or more lookup tables or configuration files to select and generate sentences that correspond to a human-readable version of the explainer model output. This human-readable explanations may provide one or more actions for the seller to take. Furthering the prior customer churn example, the actions may include providing additional discounts to the target entity. Other actions are also possible, such as an indication of a product to upsell or cross-sell to the target entity. The model executor 117 can provide these explanations in one or more user interfaces. The user interfaces may be provided as part of a web-based application, which may be provided to the user device 160 via the network 150.

Although each of the dataset identifier 114, the hierarchy generator 115, the feature set generator 116, and the model executor 117 are shown as part of and described as executed by the processing system 110, in some embodiments, one or more of the dataset identifier 114, the hierarchy generator 115, the feature set generator 116, and the model executor 117 can be transmitted to and executed at the user device 160 and/or the server 170.

The user device 160 can be operatively coupled and configured to transmit and/or receive data and/or analytical models to the processing system 110. A user (e.g., a seller) of user device 160 can use the processing system 110 (partially or fully) to request the generation of one or more features for a target entity by specifying one or more datasets or data sources, request the generation of one or more machine-learning models for a target entity, or generate one or more recommended actions. In some instances, the user device 160 can be/include, for example, a personal computer, a laptop, a smartphone, a custom personal assistant device, and/or the like. The user device 160 includes a memory, a communication interface, and a processor that can be structurally and/or functionally similar to the memory 111, communication interface 112, and the processor 113 of the processing system 110, respectively.

The server 170 can be/include devices specialized for data storage purposes and/or computing purposes that can include, for example, a network(s) of memories, a network(s) of processors, a server(s), a blade server(s), a storage area network(s), network-attached storage(s), deep learning computing servers, deep learning storage servers, and/or the like. The server 170 includes a memory, a communication interface, and a processor that can be structurally and/or functionally similar to the memory 111, communication interface 112, and the processor 113 of the processing system 110, respectively. While shown in FIG. 1 as being executed at the processing system 110, in some implementations the server 170 can be configured to execute the dataset identifier 114, the hierarchy generator 115, the feature set generator 116, and the model executor 117. In another example, the server 170 can store one or more portions of the datasets identified by the dataset identifier 114. In some implementations, the system 100 can include several servers corresponding to several different entities or sources of data.

The network 150 can be a digital telecommunication network of servers and/or computing devices. The servers and/or computing devices on the network 150 can be connected via one or more wired or wireless communication networks (not shown) to share data and/or resources such as, for example, data storage and/or computing power. The wired or wireless communication networks between servers and/or computing devices of the network 150 can include one or more communication channels, for example, a radio frequency (RF) communication channel(s), a fiber optic commination channel(s), an electronic communication channel(s), a satellite communication channel(s), and/or the like. The network 150 can be, for example, the Internet, an intranet, a local area network (LAN), a wide area network (WAN), a metropolitan area network (MAN), a worldwide interoperability for microwave access network (WiMAX®), a virtual network, any other suitable communication system and/or a combination of such networks.

Although the processing system 110, the user device 160, and the server 170 are shown and described as singular devices, it should be understood that, in some embodiments, one or more recommendation devices, one or more computing devices, and/or one or more servers can be used.

Although the dataset identifier 114, the hierarchy generator 115, the feature set generator 116, and the model executor 117 are shown and described in a singular device, it should be understood that, in some embodiments, multiple devices can be used to process and/or execute the functions of the dataset identifier 114, the hierarchy generator 115, the feature set generator 116, and the model executor 117. For example, in some embodiments, a first processing system can be used to execute the dataset identifier 114 and the hierarchy generator 115, and a second processing system can be used to execute the feature set generator 116 and the model executor 117. Other combinations are also possible, with any number of distributed processing systems executing any one or more of the dataset identifier 114, the hierarchy generator 115, the feature set generator 116, and the model executor 117.

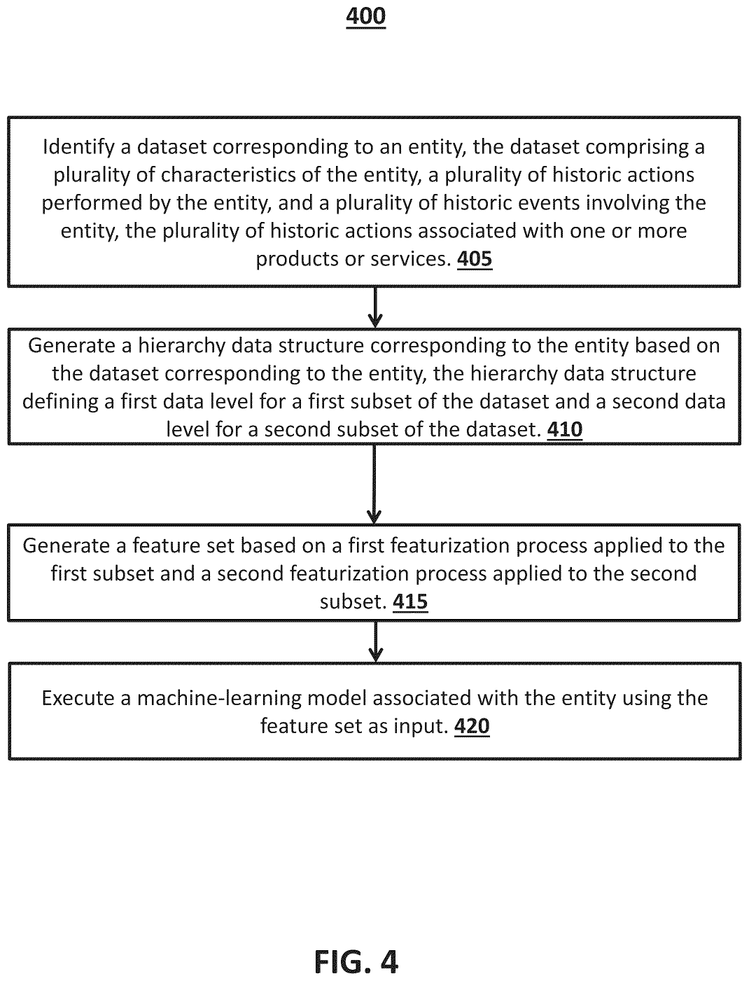

Referring to FIG. 4, illustrated is a flowchart of a method 400 for generating feature sets based on datasets corresponding to entities, according to an embodiment. The method 400 can be performed by a processor of a processing system (such as the processor 113 of the processing system 110 as shown and described with respect to FIG. 1). Although the method 400 is shown as including steps 405-420, it should be understood that in some implementations, the steps 405-420 may be performed in a different order, or steps or operations may be omitted altogether.

The method 400 can include identifying, at step 405, a dataset corresponding to a target entity (e.g., a customer). The dataset can include characteristics of the target entity (e.g., cross-sectional data/features), historic actions performed by the target entity, and historic events involving the target entity (e.g., transactional data/features). The historic actions can be associated with one or more products or services of the seller, who may request generation of a feature set via a user device (e.g., the user device 160). To identify the dataset, the processing system can execute one or more of the operations of the dataset identifier 114 described in connection with FIG. 1.

The method 400 can include generating, at step 410, a hierarchy data structure corresponding to the target entity based on the dataset identified in step 405. The hierarchy data structure can define a first data level (e.g., as corresponding to a parent entity, the target entity, or a child entity) for a first subset of the dataset and a second data level (e.g., as corresponding to the other of a parent entity, the target entity, or a child entity) for a second subset of the dataset. An example graphical representation of a hierarchy data structure, and various signals that may be included therein, is depicted in FIG. 2. To generate the hierarchy data structure, the processing system can execute one or more of the operations of the hierarchy generator 115 described in connection with FIG. 1.

The method 400 can include generating, at step 415, a feature set based on a first featurization process applied to the first subset and a second featurization process applied to the second subset. One example of a featurization process can be an aggregation featurization process. Another example of a featurization process can include a replication featurization process. Generating the feature set can include utilizing one or more featurization frameworks, such as Featuretools or Plug-N-Predict. To generate a feature set, the processing system can execute one or more of the operations of the feature set generator 116.

The method 400 can include executing, at step 420, a machine-learning model associated with the entity using the feature set as input. The machine-learning model may be one of many machine-learning models associated with and trained for the target entity. In some implementations, the processing system can execute several different machine-learning models, which each may use a portion of, or all of, the feature set generated at step 420 as input. To execute the machine-learning models, the processing system can execute one or more of the operations of the model executor 117.

Referring to FIG. 5, illustrated is a schematic illustration of an example system 500 for selecting and training models based on features of entities, according to an embodiment. The system 500 can be similar in structure to the system 100 described in connection with FIG. 1. For example, each of the user device 560, the server device 570, and the network 550 can be structurally and/or functionally similar to the user device 160, the server device 170, and the network 150 of the system 100, respectively. Likewise, the processing system 510 can be structurally and/or functionally similar to the processing system 110 of FIG. 1, and the memory 511, the communication interface 512, and the processor 513 can be structurally and/or functionally similar to the memory 111, communication interface 112, and the processor 113 of the processing system 110 of FIG. 1. The processing system 510 may include any of the components of, and perform any of the functionality of, the processing system 110 described in connection with FIG. 1, and vice versa.

Additionally or alternatively, the processor 513 can include a feature set identifier 514, a model selector 515, a model trainer 516, and/or a model manager 517, each of which can include software stored in the memory 511 and executed by the processor 513. For example, code to cause the feature set identifier 514 to retrieve or identify feature sets generated for entities, which may be stored in the memory 511. Alternatively or in addition, each of the feature set identifier 514, the model selector 515, the model trainer 516, and/or the model manager 517 can be or include a hardware-based device.

The feature set identifier 514 can identify one or more feature sets corresponding to a target entity. The feature set may be a feature set generated using the techniques described in connection with FIGS. 1-4. The target entity may be, for example, a customer of a seller that utilizes the processing system 510 to generate feature sets. The feature set identifier 514 may identify one or more feature sets for a target entity in response to a request, such as a request provided via a user interface. The user interface can be a web-based interface (e.g., an HTML web interface, etc.) or a native application interface, through which an end-user (e.g., of a seller that utilizes the processing system 510) can transmit a request to the processing system 510 to generate a set of models for a target entity. The request may specify the target entity for which the models are to be generated, an identifier of one or more feature sets corresponding to the target entity, identifiers of signals that are to be predicted relating to the entity, among others.

In response to the request, the feature set identifier 514 can retrieve the feature set corresponding to the entity. If a feature set for the target entity does not exist, or is out of date (e.g., based on timestamps corresponding to the feature set or datasets associated with the target entity), the feature set identifier 514 can generate a feature set for the target entity using the techniques described in connection with FIGS. 1-4. In some implementations, the feature set identifier 514 can identify multiple feature sets for the target entity, each of which may correspond to different time periods, datasets, or feature generation processes. The feature sets identified by the feature set identifier 514 can include ground-truth data, which may be utilized in one or more supervised or semi-supervised machine-learning algorithms, as described in further detail herein. The ground-truth data may include information relating to any of the signals that may be output by the machine-learning models generated using the techniques described herein, including but not limited to, a probability of customer (e.g., target entity) churn, a probability of customer leakage, a lifetime value of the customer, whether an upsell for the customer is recommended, whether a possibility of cross-selling a product to the customer exists, a prediction of a purchase value of an opportunity associated with the target entity, an estimation of the best time to call the target entity to engage in business, or one or more action to expedite an opportunity associated with the entity, among others. For example, the feature set identifier 514 can identify feature sets generated from historic data sets of previous customers (e.g., previous target entities) of the seller, as well as the ground truth information relating to any signals of interest for training the models described herein.

The feature sets identified by the feature set identifier 514 may be stored in an external computing system, such as the server device 570. To identify the feature sets, the feature set identifier 514 can retrieve the feature sets from the external computing system via the network 550. In some implementations, one or more of the feature sets may be stored in the memory 511. To identify the feature sets, the feature set identifier 514 can iterate through each of the feature sets stored in the memory and identify (e.g., locate with a corresponding pointer variable, etc.), each of the feature sets that are associated with the target entity. Ground truth information for any signals of interest (e.g., which may be specified in the request to generate models for the target entity) can be retrieved or identified using similar techniques. The feature sets identified by the feature set identifier 514 can then be subsequently processed by the model selector 515. In some implementations, the request can specify several target entities (e.g., several customers of the seller), and the feature set identifier 514 can identify or generate feature sets for each specified target entity. The feature sets may be utilized to train a set of models for a seller.

The model selector 515 can select a set of machine-learning models to process the feature set, for example, to achieve the best accuracy or best output possible based on the identified feature sets for the requested signals. The models can be selected as a subset of a larger set of all possible machine-learning models available. Some examples of such machine-learning models include linear regression models, logistic regression models, decision tree models, random forest model, ensemble random forest models, SVM models, naïve Bayes models, neural network models, convolutional neural network models, recurrent neural network models, long short-term memory models, k-nearest neighbors (kNN) models, k-means models, gradient boosting models such as XGBoost, or clustering models or algorithms, among others. Each

The model selector 515 can select the set of models for the target entity by iteratively providing the feature set as training data to each of the possible models, and selecting the models with the best performance for each desired signal (e.g., customer churn, upsell, cross-sell, etc.). The models with the best performance for a given signal are those that can most accurately predict the desired signal when provided the feature set (or a portion of the feature set) as input. The model selector 515 can train and score each of the possible models, to identify a set of trained models that have the highest output for a given desired signal. The model selection process may utilize a subset of the full feature set, while the full feature set may be utilized to train the models after they have been selected and the hyper parameters for those models have been optimized. The models can be scored, for example, by performing a cross-validation process, such as the holdout method, the k-fold cross validation process, or the stratified k-fold cross validation process, among others. These processes may be executed for each type of model for each desired signal (e.g., churn, upsell, etc.) to identify the best scoring model for each signal based on the feature set available for the target entity.

The model selector 515 can also determine optimal hyperparameters for each of the selected models. Each model type may be associated with a respective range of suitable hyperparameters values. The model selector 515 can iterate through the range of hyperparameters (e.g., using a random search, a binary search, or another type of search algorithm) to identify the best performing hyperparameters for each selected model. In an example randomized search, the model selector 515 can sample one or more sets of hyperparameters within the hyperparameter range(s) for a respective model, and evaluate the model's performance using the feature set (or a portion of the feature set) corresponding to the target entity. In some implementations, model selector 515 can utilize one or more portions of the tree-based pipeline optimization tool (TPOT) framework for selecting and optimizing the hyperparameters various models.

After the models have been selected and optimal hyperparameters have been determined, the model trainer 516 can fully train the selected models utilizing the feature sets as training data. As described herein, the feature sets may be associated with ground-truth data that indicates a corresponding action or event that occurred involving the target entity based on the feature set. For example, the feature set may indicate a historic customer churn, a successful (or unsuccessful) upsell or cross sell event, or an acquisition of a new customer, among other signals of interest. The signals of interest may include a probability of customer (e.g., target entity) churn, a probability of customer leakage, a lifetime value of the customer, whether an upsell for the customer is recommended, whether a possibility of cross-selling a product to the customer exists, a prediction of a purchase value of an opportunity associated with the target entity, an estimation of the best time to call the target entity to engage in business, or one or more action to expedite an opportunity associated with the entity, among others. The model trainer 516 can train the selected models using feature sets corresponding to several different target entities (e.g., several different customers of the seller).

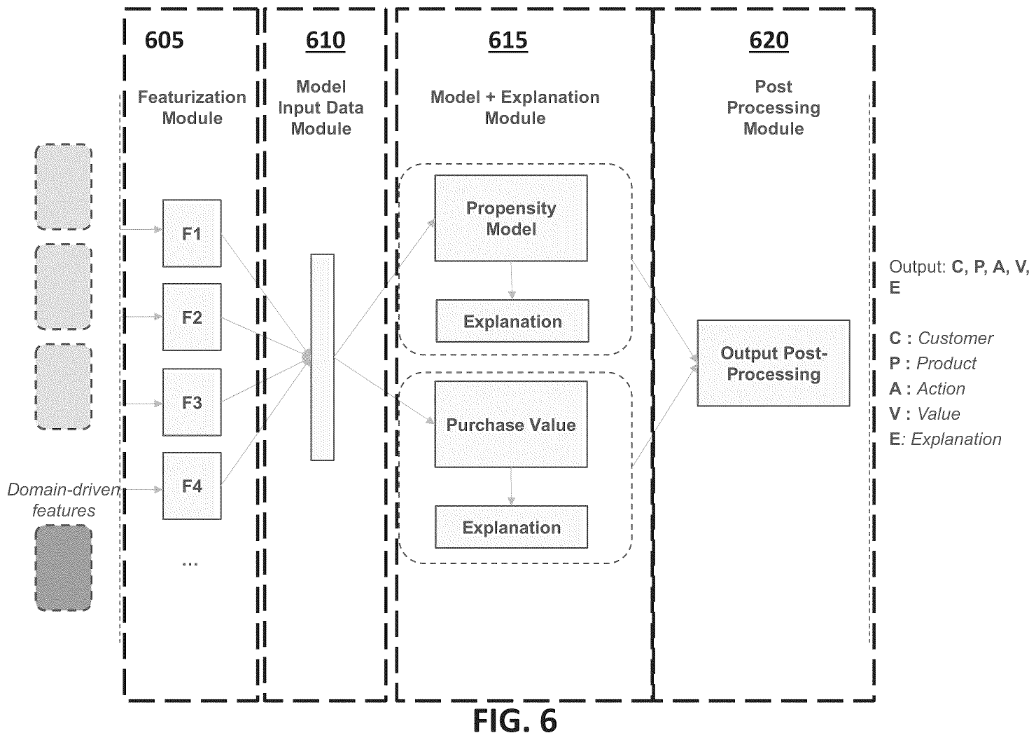

The model trainer 516 can train the models utilizing a corresponding machine-learning algorithm. The training algorithms used may be specific to each model. For example, the model trainer 516 can train a supervised machine-learning model using a supervised or semi-supervised learning algorithm, a regression algorithm, or another type of optimization algorithm depending on the type of the model. Several models can be generated for one or more target entities, or for a seller based on feature sets of several target entities (e.g., several customers of the seller). An overview of an example architecture of the machine-learning models is shown in FIG. 6.

Referring to FIG. 6 in the context of the components described in FIGS. 1 and 5, illustrated is an example data flow diagram showing an example configuration of multiple machine-learning models, according to an embodiment. This data flow diagram shows the use of the models generated and trained by the model trainer 516 in an inference stage, after the models have been trained. Although this example shows only two models (e.g., a propensity model and a purchase value model), it should be understood that any number of models may be generated for any number of desired signals. As shown, at 605, the datasets corresponding to one or more target entities (e.g., one or more customers of a seller) is provided as input to a featurization module, which may be the processing system 110 or any components thereof. The featurization module generates features from the datasets using the techniques described herein above in connection with FIGS. 1-4.

At 610, a model input data module (e.g., the model executor 117) can provide the features as input to one or machine-learning models. This may include processing some of the feature set to be compatible with the inputs of the machine-learning models (e.g., data padding, normalization, restructuring the data into a suitable data structure, other preprocessing techniques, etc.). The data input module may also select which features to input into each model. For example, certain models may only utilize some of the feature set, rather than the feature set in its entirety. The model input data module can provide each of the appropriate features as input to each model, including performing any preprocessing operations.

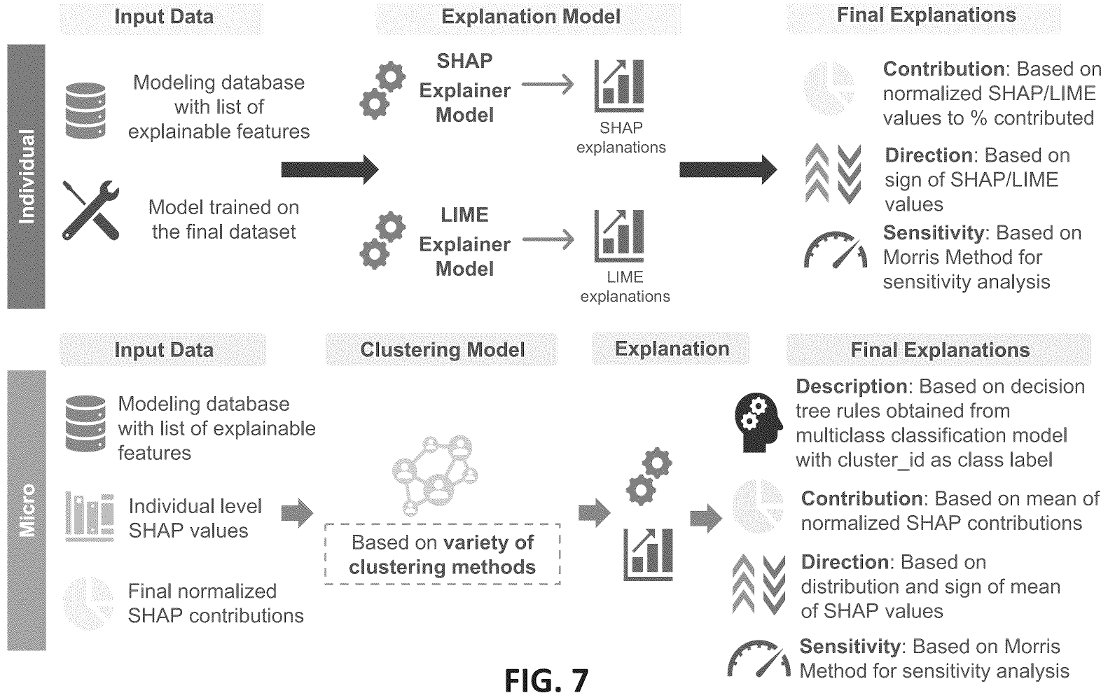

At 615, a model and explanation module (e.g., the model executor 117) can execute each of the machine-learning models generated for the requested signals. The model and explanation module can execute the machine learning models over the corresponding data provided by the model input data module. These machine-learning models may be specific to a target entity, a group of target entities, or specific to a seller having many target entities as customers. As shown, and as described in further detail herein, each machine-learning model includes an explanation model (sometimes referred to as an “explainer model”). Details of the explainer models are described herein in connection with FIGS. 5 and 7. The explainer model can provide additional context relating to the features that are most responsible for the output of each model. In this example, the explainer models can provide an indication of the features that result in the outputs of the propensity model and the purchase value model. The values output from the explainer models, and the outputs of the propensity model and the purchase value model, to an output post-processing module.

At 620, the output post-processing module (e.g., the model executor 117) can perform post-processing on the output of the models (and the corresponding explainer models) to generate one or more actions that the user can take. As shown, the output can have at least five components: a customer identifier, a product identifier, an action identifier (e.g., an action that the seller can take to remedy/improve a customer relationship), a value (e.g., any type of corresponding value relating to the outputs), and an explanation. The explanation can be a sentence explanation that indicates to a seller the one or more actions to take. Additionally, the output post-processing module may score, sort, or otherwise rank any of the actions generated by the one or more machine learning models. The scoring and ranking of the actions may be performed based on one or more rules specified by the seller. These rules may identify certain actions, customers, products, or values, which are higher in priority than other actions, customers, products, or values. The ranked list of outputs can be provided to another computing system, for example, in one or more user interfaces.

Referring back to FIG. 5, the model trainer 516 can train a respective explainer model for each of the selected and trained models. In some implementations, the model trainer 516 can train the explainer models in parallel with the training processes used for the selected models. The explainer models can be, for example, any type of Shapley Additive Explanations (SHAP) model or Local Interpretable Model-agnostic Explanations (LIME) model. The model trainer 516 can train or otherwise generate the explainer models utilizing a corresponding machine learning model and feature set as input. Depending on the type of the explainer model used, the output of the explainer model can include SHAP explanations, LIME explanations, or other explanation model outputs.

When executed, the values output by an explainer model can be used to generate various information relating to the features used as input for the machine learning model associated with the machine learning model. For example, the outputs of the explainer models can be normalized to determine a percent contribution of each feature to a particular output. Likewise, the direction of contribution can be determined based on the sign of any given SHAP/LIME explanation value. The Morris Method for sensitivity analysis can be applied to determine the overall sensitivity of the model or any given feature. Other analysis processes are also possible. An example comparison between various levels of analysis on explanation model outputs is provided in FIG. 7.

Referring to FIG. 7 in the context of the components described in connection with FIGS. 1 and 5, illustrated is a diagram showing implementations of explainer models, which may be utilized with one or more of the machine-learning models described herein, according to an embodiment. As shown in the top portion of FIG. 7, an explanation model is generated and utilized to create explanations as described in connection with FIG. 5. For example, the SHAP/LIME explainer model receives the model data (e.g., weights, biases, other factors or parameters, etc.) and any explainable features, and is trained to output explanations. The explainer models can be trained by the model trainer 516, and the explainer models can be executed (and any outputs can be further processed) by the model executor 117. For example, the model executor 117 can execute explainer models as described herein and generate the contribution, direction, and sensitivity values.

In the bottom half of FIG. 7, additional training and processing can be performed to generate micro-level analysis of explanation data. For example, the individual SHAP/LIME values, final normalized SHAP contributions, and explainable features can be provided as input to a clustering model. Various clustering models may be utilized, for example, to achieve an optimal number of clusters to understand set of entities (e.g., target entities/customers) with similar behavior to generate cohort level recommendations. The model executor 117 may execute the clustering algorithm, as part of generating an explanation for one or more machine-learning model outputs. This clustering can then be provided as input to a decision tree, the rules of which may be obtained from a multiclass classification model with the cluster identifier used as a class label. The model trainer 516 may train the multiclass classification model utilizing a suitable machine learning technique, and subsequently obtain the decision tree rules from the trained model. The output may be used to generate a description (e.g., a human readable phrase or sentence) that indicates an action or explanation for the seller based on the model outputs.

Macro-level explanations can also be generated based on the outputs of the explainer models. For example, the explainable features and SHAP/LIME explanation values can be provided as input with one or more supervised discretization decision tree classifier models. These models can be trained for each feature type, and can output one or more sub-optimal categories for each feature. These categories can be included in a global explanation on the feature level, an example of which is represented in Table 1 below.

TABLE 1

| | Bucket/ | | | | | |
|---|---|---|---|---|---|---|
| Feature | Category | Prior | Posterior | Lift | Impact | Rank |
| Cross- | Pre-defined in | % of | % of Targets | Posterior | Posterior | Based on |
| sectional or | the data or | Targets | for the | Probability/ | Probability- | Impact |
| Transactional | obtained | in the | Feature- | Prior | Prior | values for |
| | from | modeling | Bucket cut | Probability | Probability | the Feature- |
| | feature | database | of modeling | | | Bucket pair |
| | discretization | | database | | | |

The model trainer 516 can train the discretization decision tree models utilizing a suitable machine learning algorithm over the feature set and corresponding ground-truth data. The direction values generated for each feature can be used to determine the driver versus barrier nature of the feature using the impact values and the sign of mean of SHAP values for all predictions. The gain ratio for each feature can be used to determine a macro-level sensitivity value for each feature.

Referring again to FIG. 5, the model trainer 516 can utilize a teacher-student model training paradigm that is created from the explainable features to automate explainer model generation for models that predict similar signals. For example, a previously trained XGBoost churn model that utilizes a feature set generated by the feature set generator 116 to produce output may be used to train an explainer model for a decision tree classifier churn model. The explainer model may be trained by using both the predictions generated by the pre-trained model as ground truth data in addition to features that have corresponding explanations (e.g., ground truth data). This effectively increases the amount and variety of training data that is available, therefore improving the time necessary to achieve desired model accuracy for the explainer models. The model trainer 516 can implement the student-teacher paradigm when training models over similar feature sets to predict similar output values, for example, in order to improve computational efficiency over conventional training techniques.

Once the models have been trained using the identified feature sets, the model manager 517 can store the trained models in association with identifiers of any associated target entities and the seller. The models can be stored in association with a respective timestamp identifying the recency of the data used to train the model. If updated data is detected or otherwise received (e.g., via a request from the seller or from an indication received from an external computing system), the model trainer 516 can re-train or update the models based on the updated data. The model manager 517 may flag one or more models for retraining based on various conditions. For example, a seller may specify that the models should be retrained on new data on a periodic basis, or when a predetermined amount of new data is available for training. When such a condition is detected, the model manager 517 can invoke the model trainer 516 to retrain the models with the updated data. The model manager 517 may also provide indications of individual model performance, for example, in one or more user interfaces at the user device 560. Some example metrics may include PR-AUC, precision, recall, and/or MAE.

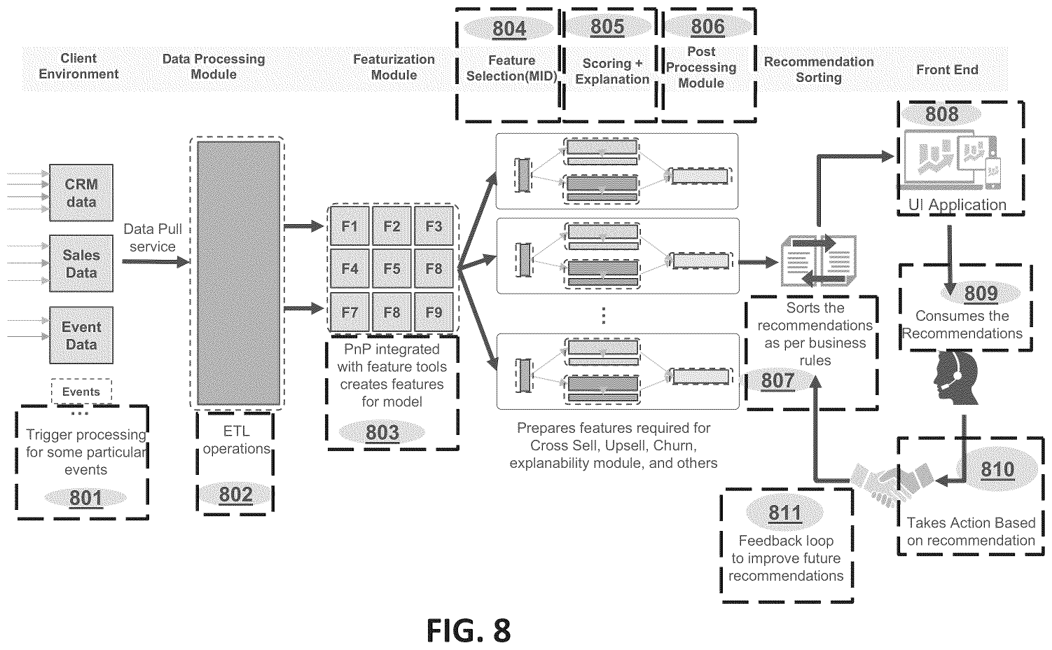

An overview of an example architecture implementing the techniques described herein is shown in FIG. 8. Referring to FIG. 8 in the context of the components of FIGS. 1 and 5, illustrated is an example data flow diagram showing how data is processed utilizing the techniques described herein, according to an embodiment. As shown, at 802, the system may perform pre-processing on datasets, and retrieve the datasets from one or more datasets. At 802, the data may be labeled according to entity (e.g., target entity, parent entity, child entity) and/or category (e.g., transactional or cross-sectional). At 803, a featurization process is performed using the techniques described herein. At 804, a model input data module (e.g., as described in connection with FIG. 6) can receive and process the feature sets for input to the machine learning models. At 805, the model executor 117 can execute one or more of the machine learning models generated and trained by the model trainer 516 over the feature sets, as described herein.

At 806, post processing model (e.g., as described in connection with FIG. 6) can post-process the explanation information at the individual, micro, and macro level described herein to produce sentence-level recommendations for a seller based on the outputs of the machine learning models. At 807, the recommendations can be ranked or sorted based on one or more seller-specified rules, as described herein, and subsequently provided for display to the seller in one or more user interface applications at step 808. At 809, the seller can observe the observations and determine whether to perform the recommended action at step 810. At step 811, the seller can provide feedback based on whether the seller took action based on the recommendation to improve the recommendation rankings or rules.

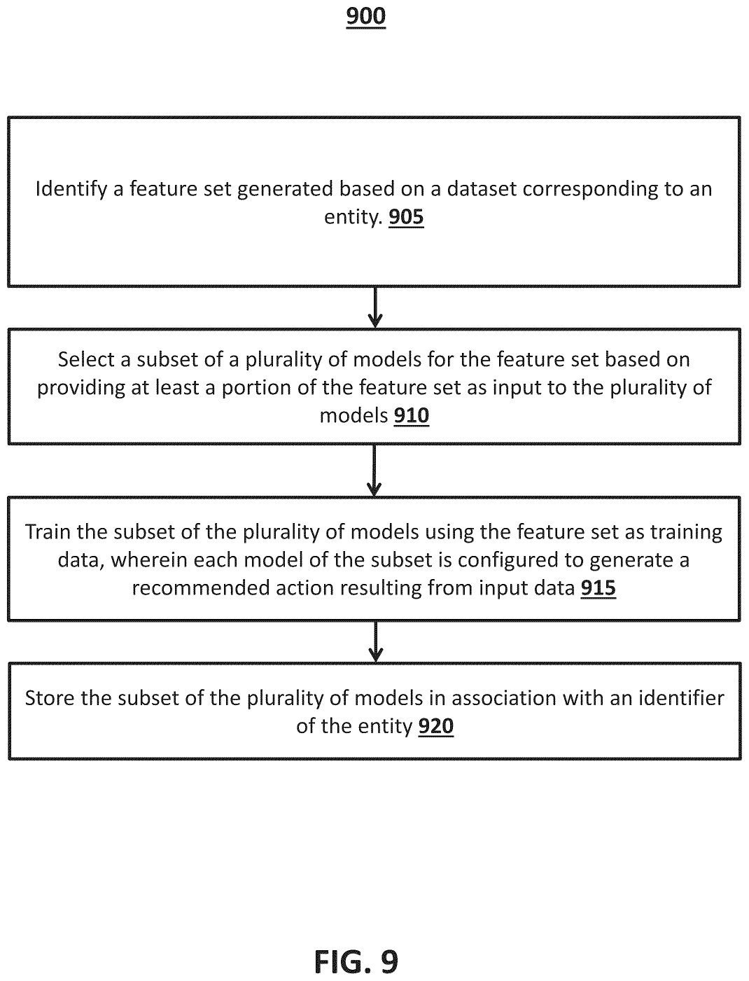

Referring to FIG. 9, illustrated is a flowchart of a method 900 for generating feature sets based on datasets corresponding to entities, according to an embodiment. The method 900 can be performed by a processor of a processing system (such as the processor 513 of the processing system 510 as shown and described with respect to FIG. 5). Although the method 900 is shown as including steps 905-920, it should be understood that in some implementations, the steps 905-920 may be performed in a different order, or steps or operations may be omitted altogether.

The method 900 can include identifying, at step 905, a feature set generated based on a dataset corresponding to an entity. To identify the feature set, the processing system can execute one or more of the operations of the feature set identifier 514 described in connection with FIG. 5. The dataset from which the dataset was generated may include characteristics of the target entity (e.g., cross-sectional data/features), historic actions performed by the target entity, and historic events involving the target entity (e.g., transactional data/features). The historic actions can be associated with one or more products or services of the seller, who may request generation of a feature set via a user device (e.g., the user device 160).

The method 900 can include selecting, at step 910, a subset of a larger set of models for the feature set by providing at least a portion of the feature set as input to the models. The processing system can do so to determine which of the models are optimal for a given target signal (e.g., a churn probability, upsell prediction, cross-sell prediction, among others described herein) and a given feature set (e.g., for a seller, a target entity, or selected group of target entities, etc.). To select the models, the processing system can execute one or more of the operations of the model selector 515 described in connection with FIG. 5.

The method 900 can include training, at step 915, the subset of models using the feature set as training data. Each model of the subset can generate a recommended action resulting from input data. For example, each of the models may include explainer models, the output of which may be utilized in connection with further machine-learning models and techniques (e.g., as described in connection with FIGS. 5-8) to generate human-readable explanations based on model output. The selected models and corresponding explainer models can be trained, for example, by performing one or more of the operations of the model trainer 516, as described herein.

The method 900 can include storing, at step 920, the subset of models in association with an identifier of the entity and an identifier of the seller. The models can be stored and may be periodically updated, for example, in response to datasets of one or more target entities being updated, in response to a predetermined time period elapsing since the models were last trained, or in response to a request from a seller. The processing system can store and update the models by performing one or more of the operations of the model manager 517 of FIG. 5.

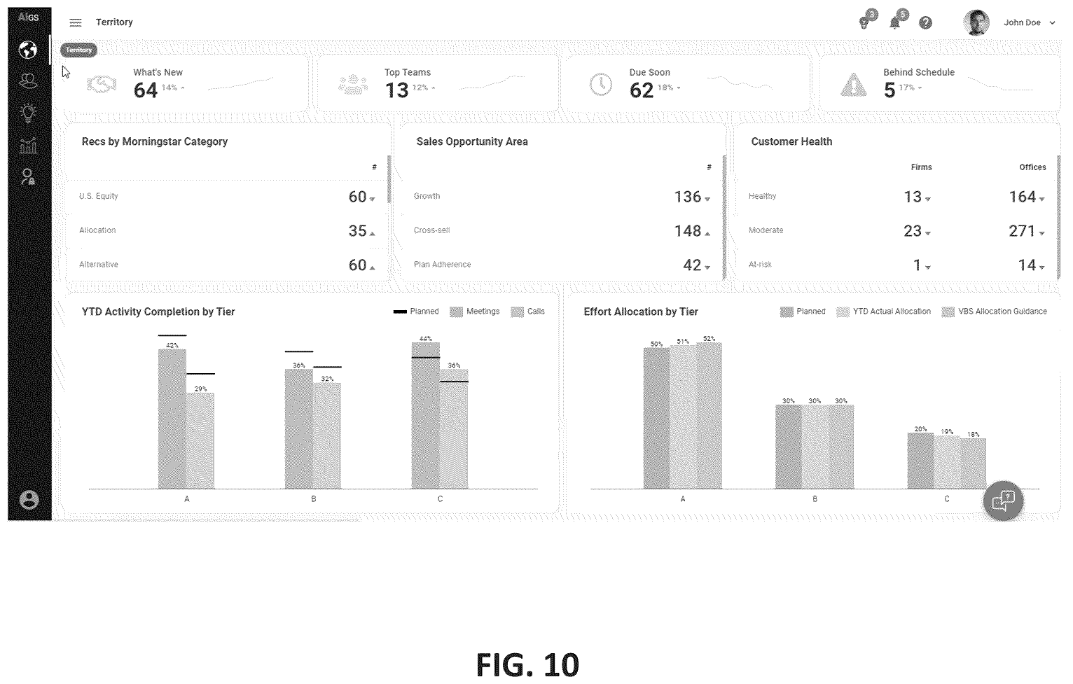

Referring to FIG. 10 described in connection with the components of FIGS. 1 and 5, illustrated is an example user interface showing a performance summary of a seller organization, according to an embodiment. The user interface can be provided by the processing system 110, the processing system 510, or another computing system in communication with the processing system 110 or the processing system 510. As shown, the user interface of FIG. 10 includes various information about the seller organization, including activity metrics, customer metrics, and sales-related metrics. The user interface may be accessed by a computing device of the seller, such as the user device 160 or the user device 560. The user interface can include various interactive user interface elements (e.g., links, buttons, etc.) that enable a seller to request other information or to navigate to other user interfaces described herein.

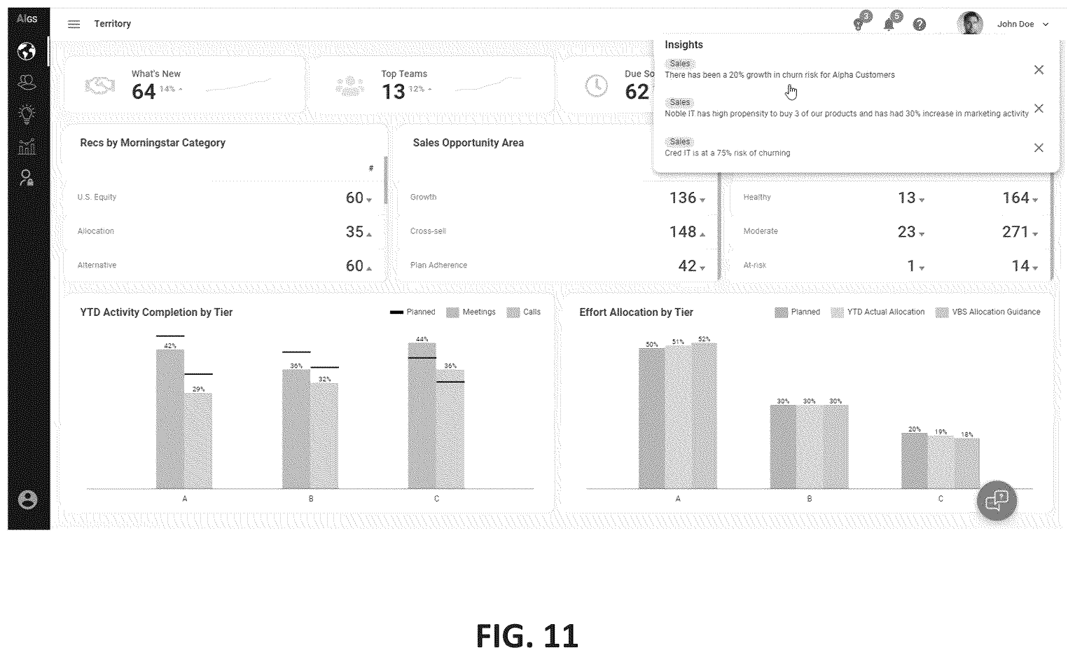

Referring to FIG. 11 described in connection with the components of FIGS. 1 and 5, illustrated is an example user interface showing an overlay that includes some of the signals derived from the machine learning techniques described herein. As shown, the user interface of FIG. 10 has displayed an additional overlay which shows various metrics corresponding to customers. These may be displayed, for example, in response to one or more signals generated from executing the machine learning models described herein. The insights shown in the overlay may be examples of the human-readable sentences generated based on the machine learning models (e.g., “Cred IT is at a 75% chance of churning”).

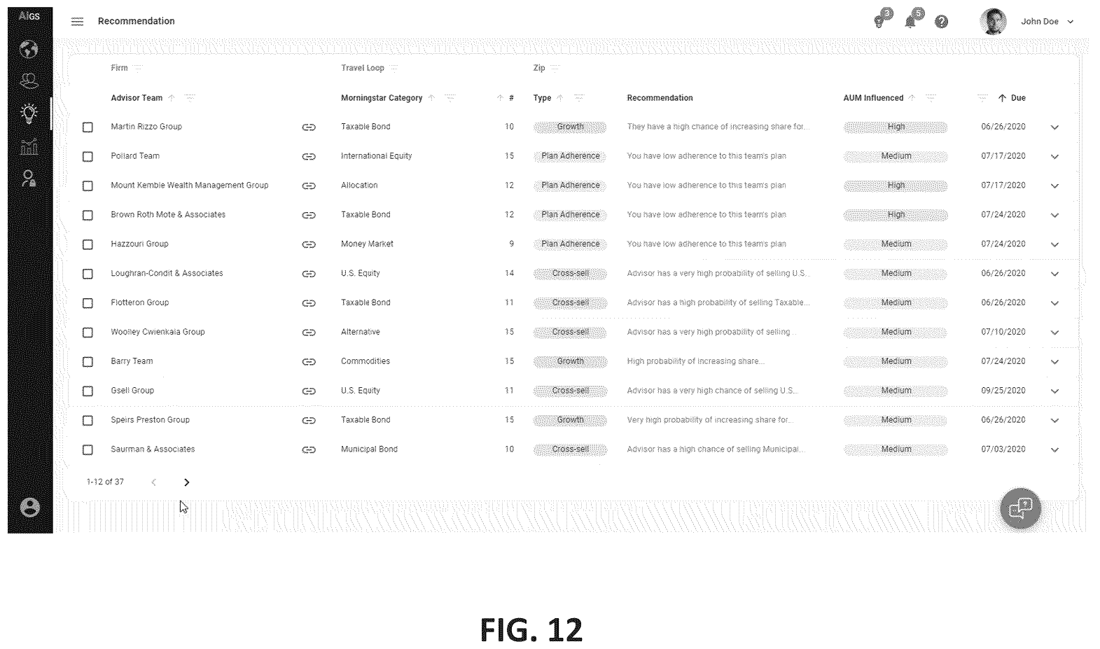

Referring to FIG. 12 described in connection with the components of FIGS. 1 and 5, illustrated is an example user interface showing a list of recommendations for various customers of the seller. These recommendations may include the one or more human-readable actions generated using the machine learning techniques described herein. As shown, each entry in the list identifies a corresponding customer, a category of the customer, the number of recommendations generated for the customer, an interactive human-readable explanation of the recommendation (which in this case is an interactive hyperlink), a recommendation type (e.g., growth, plan adherence, cross-sell, etc.), and an overall potential revenue impact (shown in each row as “AUM Influenced”). Each row can include a drop-down arrow, that when interacted with, causes each of the recommendations associated with the corresponding customer to be displayed. Each entry in the list of recommendations may be ranked according to one or more metrics, for example, based on the overall revenue impact of the recommendation.

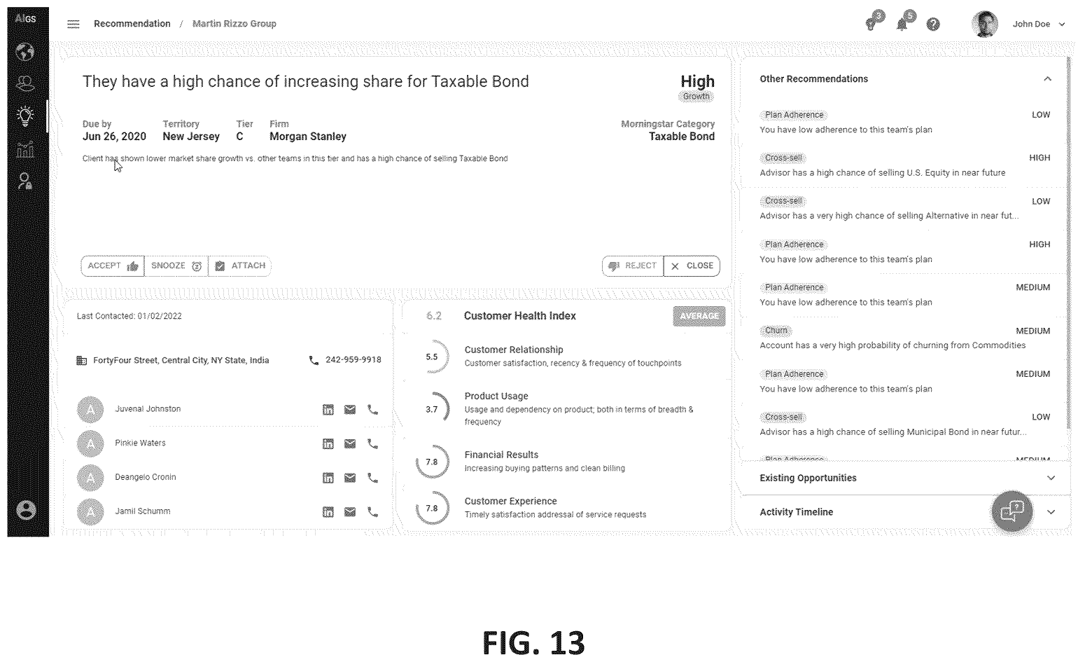

Referring to FIG. 13 described in connection with the components of FIGS. 1 and 5, illustrated is an example user interface showing details of a customer, including recommendations or actions generated using the techniques described herein, according to an embodiment. When an interaction occurs with the interactive recommendation hyperlink of FIG. 12, the web-based application can navigate to the user interface shown in FIG. 13 to display information relating to the corresponding customer and recommendation. This user interface includes an “Accept,” “Snooze,” “Attach,” and “Reject” recommendation. These can act as the corresponding feedback described herein, to train the recommendation processes described herein. Also displayed is a Customer Health Index metric, which provides an overall indication of the relationship between the seller and the customer. If a recommendation is accepted

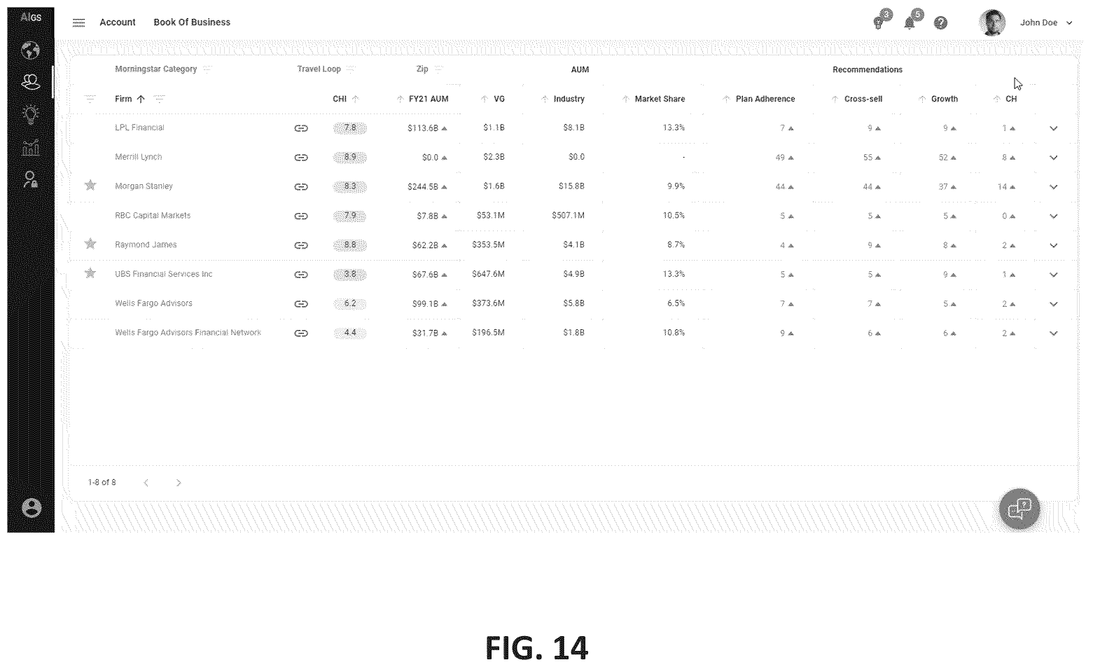

Referring to FIG. 14 described in connection with the components of FIGS. 1 and 5, illustrated is an example user interface showing a summary of various customers or potential customers of a seller. Each row in the list of FIG. 14 can correspond to a customer. As shown, each row includes a customer health index (CHI) value, an amount of assets under management (AUM), an overall amount of revenue of the customer (shown under “VG”), total revenue of the industry to which the customer belongs, the market share of the customer in that industry, and numbers of recommendations for the customer relating to plan adherence, cross-selling opportunities, growth, and customer health.

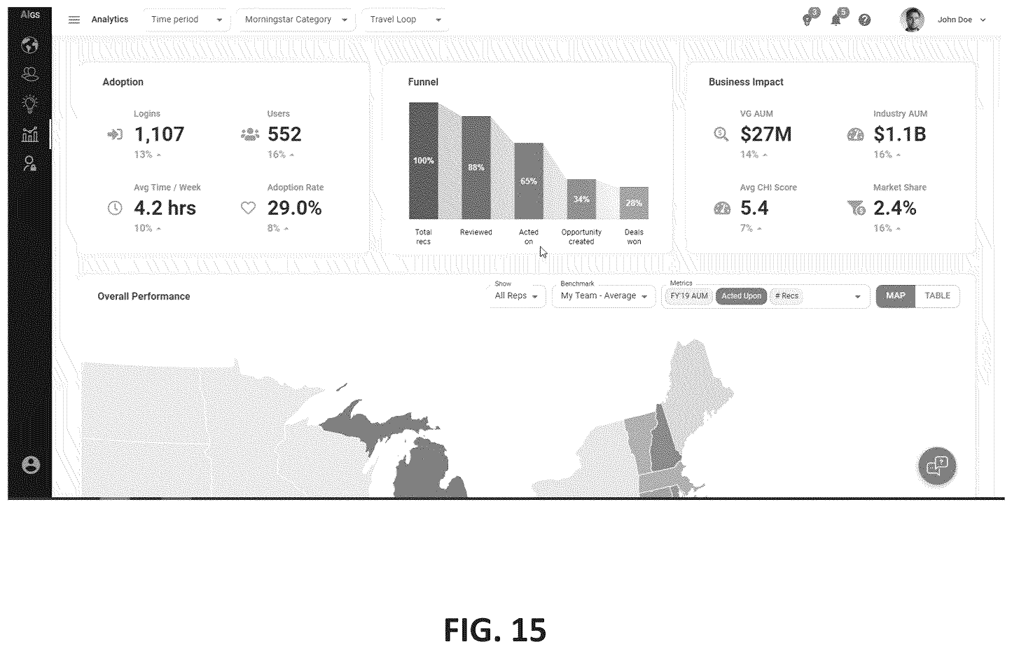

Referring to FIG. 15 described in connection with the components of FIGS. 1 and 5, illustrated is an example user interface showing a summary of various customers or potential customers of a seller. As shown, this user interface includes several signals relating to adoption of the platform provided by the present techniques including number of logins, average use time, number of users, adoption rate, as well as metrics relating to recommendations. The interface also shows an example business impact of the present techniques, which includes information about increased AUM, increased CHI, and market share.

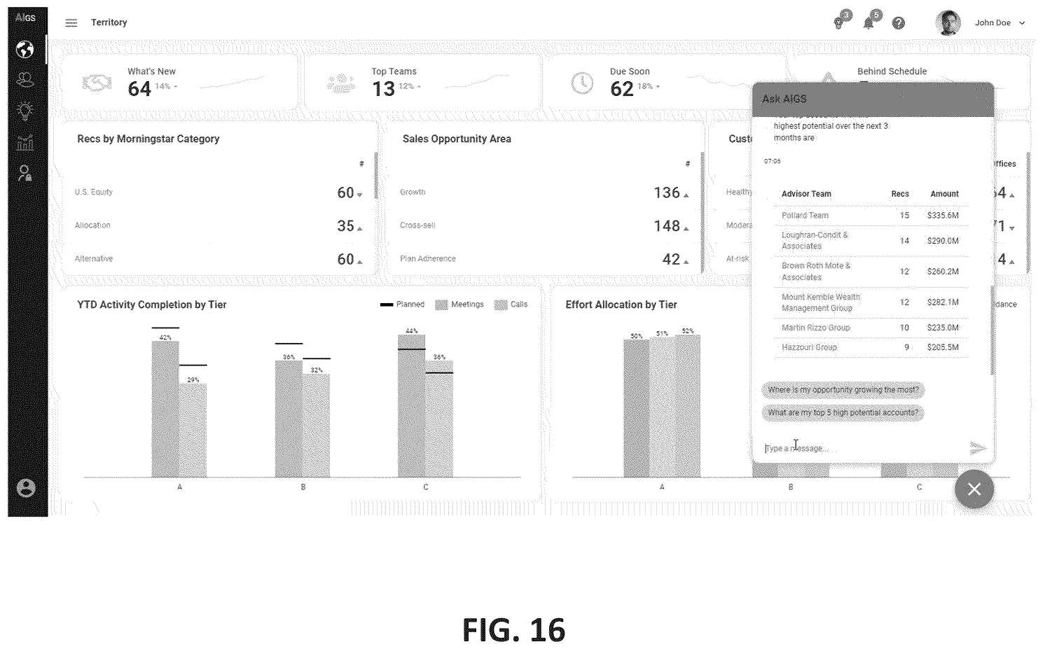

Referring to FIG. 16 described in connection with the components of FIGS. 1 and 5, illustrated is an example user interface showing an example chatbot that may be used to provide requests to the processing systems described herein. As shown, the chatbot may appear in response to an interaction with an interactive user interface element shown at the bottom right of the screens shown in FIGS. 10-15. The chatbot may be used by the seller to provide requests, for example, for one or more recommendations relating to one or more customers. The processing systems 110 or 510 can execute one or more natural language processing algorithms to interpret seller requests and can execute corresponding operations described herein in accordance with the requests.

It should be understood that the disclosed embodiments are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. Thus, it is to be understood that other embodiments can be utilized and functional, logical, operational, organizational, structural and/or topological modifications may be made without departing from the scope of the disclosure. As such, all examples and/or embodiments are deemed to be non-limiting throughout this disclosure.

Some embodiments described herein relate to methods. It should be understood that such methods can be computer implemented methods (e.g., instructions stored in memory and executed on processors). Where methods described above indicate certain events occurring in a certain order, the ordering of certain events can be modified. Additionally, certain of the events can be performed repeatedly, concurrently in a parallel process when possible, as well as performed sequentially as described above. Furthermore, certain embodiments can omit one or more described events.

All definitions, as defined and used herein, should be understood to control over dictionary definitions, definitions in documents incorporated by reference, and/or ordinary meanings of the defined terms.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field-programmable gate array (FPGA), and/or an application-specific integrated circuit (ASIC). Software modules (executed on hardware) can be expressed in a variety of software languages (e.g., computer code), including C, C++, Java™ Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and software development tools. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of automated feature generation for entities, comprising:
identifying, by one or more processors coupled to a non-transitory memory, a dataset corresponding to an entity, the dataset comprising a plurality of characteristics of the entity, a plurality of historic actions performed by the entity, and a plurality of historic events involving the entity, the plurality of historic actions associated with one or more products or services;
generating, by the one or more processors, a hierarchy data structure corresponding to the entity based on the dataset corresponding to the entity, the hierarchy data structure defining a first data level for a first subset of the dataset and a second data level for a second subset of the dataset;
generating, by the one or more processors, a feature set based on a first featurization process applied to the first subset and a second featurization process applied to the second subset; and
executing, by the one or more processors, a machine-learning model associated with the entity using the feature set as input.

2. The method of claim 1, comprising generating, by the one or more processors, an explanation value based on an output of the machine-learning model.

3. The method of claim 1, wherein the plurality of characteristics further comprise at least one second characteristic of a second entity associated with the entity, and the plurality of historic actions comprise at least one second historic action performed by the second entity.

4. The method of claim 1, wherein the hierarchy data structure separates the dataset corresponding to the entity into at least two categories based on a type of information in the dataset.

5. The method of claim 1, comprising combining, by the one or more processors, an output of the first featurization process with an output of the second featurization process to generate the feature set.

6. The method of claim 1, wherein the first subset of the dataset corresponds the entity and the second subset of the dataset corresponds to the entity and a sub-entity of the entity.

7. The method of claim 1, wherein the first featurization process or the second featurization process comprises an aggregation or replication process.

8. The method of claim 1, wherein the machine-learning model comprises a plurality of models, and wherein executing the machine-learning model comprises providing, by the one or more processors, the feature set as input to the plurality of models.

9. The method of claim 8, wherein the plurality of models comprises at least one clustering model.

10. The method of claim 1, updating, by the one or more processors, the machine-learning model responsive to generating the feature set.

11. A method, comprising:
identifying, by one or more processors coupled to a non-transitory memory, a feature set generated based on a dataset corresponding to an entity;
selecting, by the one or more processors, a subset of a plurality of models for the feature set based on providing at least a portion of the feature set as input to the plurality of models;
training, by the one or more processors, the subset of the plurality of models using the feature set as training data, wherein each model of the subset is configured to generate a recommended action resulting from input data; and
storing, by the one or more processors, the subset of the plurality of models in association with an identifier of the entity.

12. The method of claim 11, wherein the dataset comprises a plurality of characteristics of the entity, a plurality of historic actions performed by the entity, and a plurality of historic events involving the entity.

13. The method of claim 11, wherein the plurality of models comprise a churn model, an up-sell model, and a cross-sell model.

14. The method of claim 11, wherein the plurality of models comprises at least one of a linear regression model, a random forest model, a sparse vector machine (SVM) model, or an extreme gradient boosting (XGBoost) model.

15. The method of claim 11, wherein selecting the subset of the plurality of models comprises determining, by the one or more processors, a respective set of hyperparameters for each model of the subset of the plurality of models.

16. The method of claim 15, wherein selecting the respective set of hyper parameters comprises performing, by the one or more processors, a randomized search over a hyperparameter range based on a type of the model.

17. The method of claim 11, further comprising updating, by the one or more processors, at least one model of the subset responsive to an update to the dataset corresponding to the entity.

18. The method of claim 11, further comprising updating, by the one or more processors, at least one model of the subset after a predetermined time period has elapsed.

19. The method of claim 11, wherein each of the subset of the plurality of models further comprise an explainer model.

20. The method of claim 11, further comprising presenting, by the one or more processors, a result of training the subset of the plurality of models.
